(19) United States
(12) Patent Application Publication
(10) Pub. No.: US 2014/0234735 A1
(43) Pub. Date: Aug. 21, 2014

(54) HIGH TEMPERATURE FUEL CELL/ELECTROLYZER SYSTEM WITH ENERGY STORAGE MEDIA AND AUXILIARIES OUTSIDE THE FUEL CELL POWER GENERATOR

(71) Applicants: Gong Zhang, Murrysville, PA (US); Arun K. S. Iyengar, Monroeville, PA (US)

(72) Inventors: Gong Zhang, Murrysville, PA (US); Arun K. S. Iyengar, Monroeville, PA (US)

(21) Appl. No.: 13/769,610

(22) Filed: Feb. 18, 2013

(51) Int. Cl. H01M 16/00; C25B 9/06

(52) U.S. Cl. CPC H01M 16/003; C25B 9/06
USPC 429/422; 429/423; 204/274

(57) ABSTRACT

A fuel cell system (10) basically containing an energy storage subunit (14) which receives feed fuel (17) or recirculated fuel (23) both containing H₂ where either fuel is contacted with a metal in the energy storage subunit (14) to provide a H₂ rich fuel (18) to a fuel cell power generator (20) that is completely separated from all other components such as possible reformers (13), thermal energy sources (16) and storage media subunits (24, 35).

### BACKGROUND

1. Field of the Invention

The invention relates to fuel cell systems utilizing (reduction/oxidation) reaction components which provide a means to store and release electrical energy by recirculating and treating fuel cell spent fuel gas using energy and thermal storage material subunits exterior to the fuel cell power generator.

2. Description of Related Art

Ceramic fuel cells are energy conversion devices that electrochemically combine carbon fuels and oxidant gases across an ionic conducting solid electrolyte and are disclosed in detail by Nguyen Q. Minh in J. Am Ceram. Soc., 76[3]563-88 (1993) “Ceramic Fuel Cells.” FIG. 1 shows general solid electrolyte fuel cell (SOFC) operation, where solid electrolyte 1 is sandwiched between an anode 2, which receives fuel/reformed fuel 3 and a cathode “air” electrode 4 which receives air/oxidant 5 to generate electrons (electricity) 6.

The reformed fuel has many impurities such as sulfur removed in a fuel gas reformer. Generally, the fuel is additionally passed through a flow controller, a burner, a heat exchanger with a recirculation pump, a compressor, and oxygen-sensor valve, as described by Singh et al. in U.S. Pat. No. 5,928,805.

What is needed is a fuel cell system which functions to keep most or all auxiliaries including advanced energy storage subsystems, thermal energy storage subsystems, start-up fuel streams, reformers, etc. outside of the fuel cell power generation main system. It is a main object of this invention to provide such a separated system during fuel cell operation, to provide multiple fuel cell options including energy storage functions.

Solid oxide system applications were discussed by W. L. Lundberg in Proceedings of the 25^{th} Intersociety Energy Conversion Engineering Conference, Vol. 3, IECEC-90; Aug. 12-17, 1990 Reno, Nevada; “System Applications of Tubular Solid Oxide Fuel Cells.” This document discusses desulfurizers, preheaters for the air stream, power conditioners and their association in a coal powered SOFC plant. Other systems patents include, for example, U.S. Pat. Nos. 5,047,299; 6,255,010; 6,689,499 and 7,320,836 (Shockling; George et al.; Gillett et al.; and Draper et al.). Noguchi et al. (U.S. Pat. No. 4,622,275) relates to molten carbonate fuel cell systems.

Energy storage devices using fuel cell generators described in the U.S. Pat. No. 5,492,777 and the US Patent Application No. 20110033769 (Isenberg & Ruka; and Huang et al.). integrate tightly the energy storage media both spatially and thermally with the fuel cell generator. In addition to introducing additional complexities to the design and operation of the fuel cell energy storage device, the energy storage capacity and the power generation ratings are strongly interlinked curtailing the ease of scaling up/down the system capacity for use in different applications economically without a re-design. It also affects the ease of repairability and availability of the system as the entire system has to be shutdown to maintain/repair either the power generation or energy storage function.

As pointed out by Grimble in U.S. Pat. No. 4,729,931, at least as to reformers and presumably as to other auxiliaries: “Until now, the reforming of the fuel had to be performed outside of the fuel cell generator because no one had discovered how this chemical process could be performed within the generator structure itself Reforming outside of the fuel cell generator required the use of heat exchangers, pumps, and other types of equipment. U.S. Pat. No. 4,128,700 (Sederquist), for example, illustrates the reforming of a fuel outside of the fuel cell generator. The reforming of fuel outside the generator is undesirable as it results in a loss of energy as heat in the reformer and in conduits between the generator and the reformer, and the apparatus is more complicated, requires more space, and is more expensive.” In general, the more components within the fuel cell generator, the more complicated and costly the design.

### SUMMARY

This invention solves the above problems and provides the above objective by providing a fuel cell/electrolyzer system capable of charging and discharging, with an energy storage function, comprising: (a) a source of fuel; (b) a source of electricity; (c) an optional reformer receiving the source of fuel and outputting a feed stream of H₂O/steam; (d) a feed stream of H₂O/steam; (e) an energy storage subunit which receives the feed stream and which subunit contains a metal based material which provides a metal oxide and hydrogen at discharge where the metal oxide is retained in the energy storage subunit providing hydrogen rich fuel of H₂ and steam with a volume % ratio hydrogen:steam of 60 to 75:25 to 40; (f) a thermal energy source to heat the discharged hydrogen rich and steam to provide a hydrogen rich. and steam fuel entry stream having a temperature over about 750° C., preferably 750° C. to 850° C.; (g) a fuel cell power generator/electrolyzer that is completely separated from all other components in the system, which fuel cell power generator/electrolyzer receives the heated, hydrogen rich H₂ and steam entry stream, said fuel cell power generator/electrolyzer providing energy out, depleted oxidant out and depleted H₂ fuel of H₂O and steam; and which electrolyzer will split water into H₂ and O₂ during charging when the electricity source is fed into the system; (h) an oxidant source which is passed to the fuel cell power generator/electrolyzer; and (i) separate additional storage media subunit containing a metal based material to be fed with depleted fuel out, which metal based material will chemically charge the depleted H₂ fuel of H₂ and steam exiting the fuel cell power generator/electrolyzer, to provide recirculated fuel of higher H₂ content plus steam which is passed to the energy storage subunit of (e); where at steady state operation the source of fuel (a), and optional reformer (c) can be eliminated or their output reduced. The fuel cell power generator/electrolyzer acts as a fuel cell to provide electricity out but can also act as an electrolyzer when electricity is fed in naturally only one function at a time. By “steady state” is meant after start-up, where substantial recirculation has occurred.

### BRIEF DESCRIPTION OF THE DRAWINGS

For a better understanding of the invention, reference may be made to the Summary and preferred embodiments exemplary of the invention, shown in the accompanying drawings, in which:

FIG. 1 is a schematic illustration of one type of prior SOFC operation; and

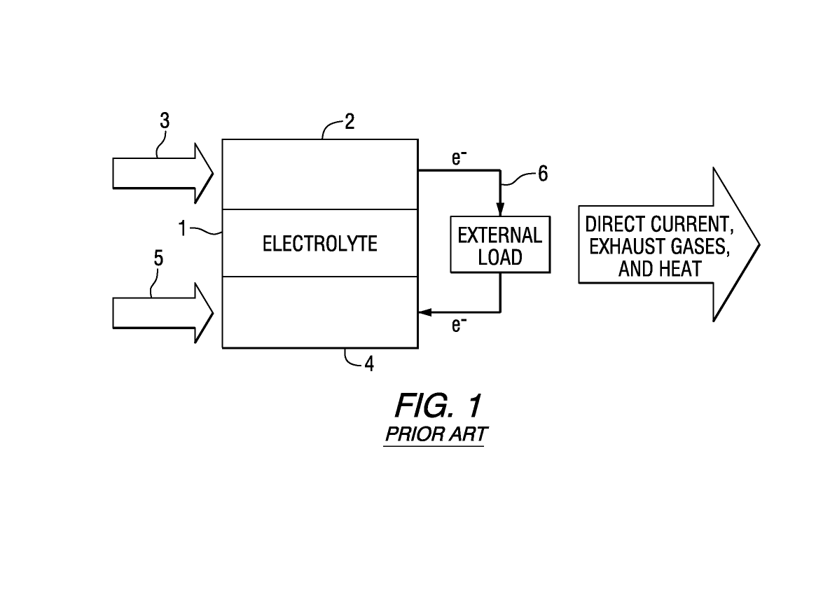

FIG. 2, which best shows the invention, is a schematic flow diagram of the basic system of this invention utilizing a stand-alone fuel cell power generator.

### DESCRIPTION OF THE PREFERRED EMBODIMENTS

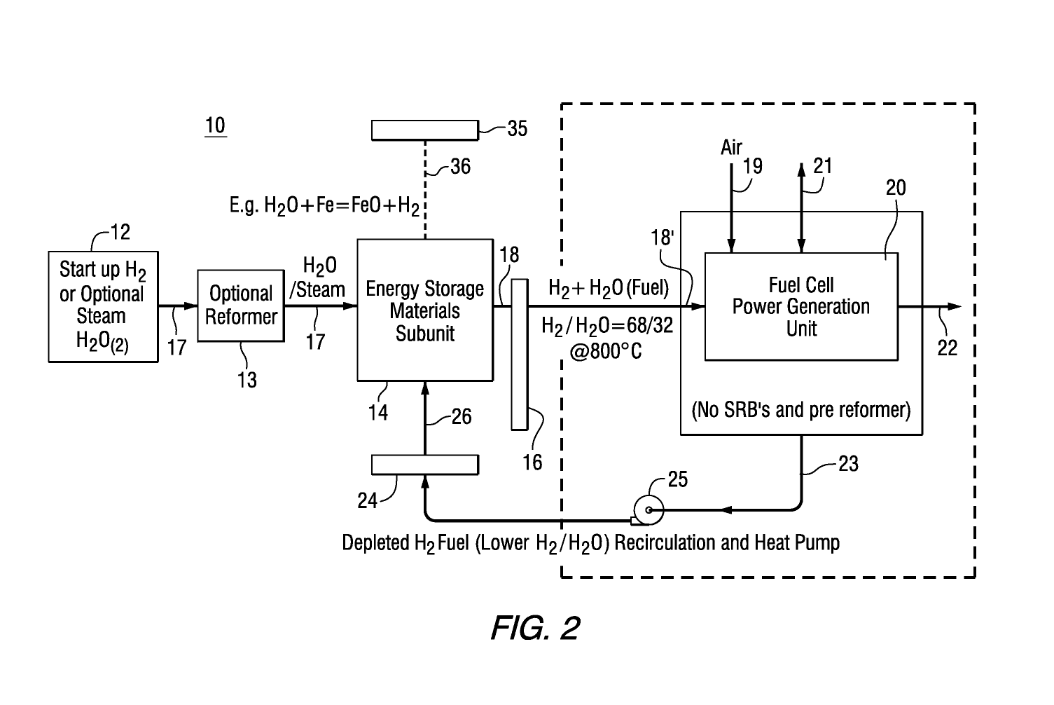

The main feature of this fuel cell/energy storage system 10 is to keep the energy storage media outside of/away from the cell negative electrode of the fuel cell power generator/electrolyzer (20). As shown in FIG. 2, for example, the invention comprises a start-up fuel source 12, which can be a carbonaceous fuel such as natural gas or H₂+H₂O (g) (steam); optional reformer 13 if carbonaceous fuel is used as the fuel source, providing a stream of H₂O/steam 17, an energy storage material subunit 14 which provides HI and as fuel 18 and heated H₂ and steam fuel 18′ after passing through a thermal energy source 16 such as a heater or a heat exchanger, etc. Input fuel cell air source is shown as 19 and a simplified fuel cell power generation/electrolyzer unit as 20. The two “units” power generator 20, which also functions as an electrolyzer with input electricity, with an energy storage function and storage material subunit 14 work in sync during charging and discharging processes. During the discharging process, the power generation/electrolyzer unit 20 generates power and releases spent fuel 23 having a high water/hydrogen ratio. The spent fuel 23 is re-circulated by a high temperature pump 25 to the storage media 24, and as a result, water reacts with storage media 24 and converts to fresh fuel of high hydrogen/water ratio 26. During the charging process, electricity is reversed and is fed into the power generation unit, acting as an electrolyzer, and water is split to generate hydrogen which hydrogen plus steam is fed to the storage material subunit. The storage materials are charged by the hydrogen into a reduced or charged state. A source of electricity in and electricity out of (and into) the fuel cell power generator is shown as in and out arrows 21 and depleted oxidant/O₂ as 22. The charged storage material can then be used to generate the hydrogen needed by the fuel cell for generating power by going through the discharge process described above.

When the system is started, initial steam and/or hydrogen 12 is fed to start up the fuel cell 20, while the system is being heated up. At steady state, the operating system should be self-sustainable, and a continuous external steam supply is not necessary.

A metal material which can provide a metal oxide and hydrogen, such as iron, for example, can be used as a preferred energy storage material in subunit 14, to absorb oxygen as FeO during discharge while releasing oxygen to the reacted depleted H₂ fuel 26 during charge. Once the energy storage materials are used up during discharge, these metal materials can simply be replaced with fresh materials or regenerated in situ through electric charging. In addition to use of the storage media 24 through which recirculated fuel is passed to an optional, separate storage media subunit 35 can be utilized through feed 36 to directly add storage material to the storage material subunit 14. Electricity fed from outside, downward arrow 21, can turn the power generator into an electrolyzer, create hydrogen, and thus convert iron oxides to iron and water. As a parallel and maintenance option, chemical charging with a reducing agent could also be carried out in a separate operation.

In general, the energy storage media will generate heat during its hydrogen production mode (discharge), while it will need external heat during bed regeneration (charge). The heat generated/absorbed is not expected to be larger than 20% of the heat generated/absorbed in the power generating unit during operation in a fuel cell/electrolysis mode, respectively. The recirculation flow rate can be tailored to provide the necessary heat during charge and absorb the heat during discharge via sensible heat exchange. Alternately, the storage media subunit(s) can be situated in close proximity of the stack to absorb heat from the stack.

In addition, a variety of thermal storage materials can be added to the anode gas recirculation loop to store the excess heat generated during discharge and supply it back during charge, thereby increasing the round trip efficiency of the system. Thermal storage may include materials that can store the heat in the form of sensible heat, latent heat, chemical energy or a combination of these. The introduction of thermal energy storage can also be used to mitigate heat loss from the external storage beds. Note that thermal storage material can be either part of the storage bed itself or be external to the bed. For example, particles of thermal storage materials can be mixed with the active material of the storage bed. The thermal storage material can also surround the bed itself to provide a thermal blanket to the storage bed.

With the separation of energy storage materials from the fuel cell generation unit 20, there are a few advantages elaborated below in the following paragraphs:

The general volume % ratios of H₂:steam are: stream 18′, from 60-75:25-40, preferably 64-75:25-36, this is the heated fuel 18′ entering the fuel cell power generator/electrolyzer. In recirculated spent H₂ depleted fuel out, 23; H₂:steam is from 20-4:60-80 and recirculated regenerated fuel stream 26, the H₂:steam is from 60-75:25-40.

This system allows flexible selection of cell, catalyst and storage materials. As the electrode materials in fuel cell and energy storage materials are separated physically, it provides a greater degree of flexibility in material selections to achieve power generation in fuel cell and storage functions in storage materials without negatively affecting each other. The storage metal material is defined as selected from the group consisting of: Fe, Mn, Co, Cr, Al, Zr, Sc, Y, La, Ti, Hf, Ce, Cr, Ni, Cu, Nb, Ta, V, Mo, Pd, W and their alloys, halides, sulfates, sulfites, and carbonates; with Fe, Mn, Co, Cr, Al, Zr or their alloys or oxides preferred, and with Fe and its alloys or oxides most preferred.

This system allows easier scale-up with current power generation technologies. Without changing the core cell components in fuel cells, it is much easier and faster to scale up the battery system based on current fuel cell technologies. For the same reason, the separate storage media can be integrated with any compatible power generation devices, such as SOFC, phosphoric acid fuel cell (PAFC), molten carbonate fuel cells (MCFC), and Proton exchange membrane (PEM) fuel cell. Preferably, the fuel cell power generation/electrolyzer system comprises a plurality of electrodes which receive the heated hydrogen rich and steam fuel entry stream and a plurality of “air” electrodes which receive and oxidant source, with electrolyte between each anode and air electrode.

This system allows maximization of power density of the power generation/electrolyzer subunit; without storage material in the negative electrode compartment, the power density of the power generation subunit can be maximized to its limits.

This system allows optimization of the energy storage according to the desired application. As the energy storage material can be placed in a stand-alone unit, it is much easier to change the size of the storage tank to increase energy storage without affecting cell operation. More storage materials can be added to compensate slow material oxidation and reduction kinetics should that be the case.

This system allows flexible charging and maintenance options. As the energy storage unit is separated from the power unit, the spent energy storage materials can be simply replaced with fresh materials without interrupting normal system operations. This can be achieved by installing a secondary energy storage unit which the system can use when the primary storage unit is switched off. The storage materials can also be chemically regenerated by flowing reducing agents. The third option is to charge it by reversing fuel cell operation which pumps oxygen out of fuel stream and reduces energy storage materials.

This system allows balancing of cells in battery mode. It is critical, in traditional rechargeable batteries, that cells in a battery are balanced electrically during operation due to the fact that the thermodynamics and kinetics of individual cells are controlled locally by their storage media in the electrodes of each cell. When a large number of cells are assembled, variations in storage media performance are normal. In practice, the cell balancing is usually achieved by sophisticated electronics. However, this approach is uneconomical for most fuel cell systems. By separating power generation and energy storage functions, this concept allows all cells to be balanced without complex circuitry by the same uniform oxygen partial pressure, which is controlled by a common storage bed.

Since the discharging process is done by the power generating unit, the potential issue with the new approach is mainly how fast the storage materials, such as iron, can convert water into hydrogen and absorb oxygen from spent fuel. The reaction and flow kinetics in the separate storage tank can be studied and optimized independently of the power generating unit making the implementation of the new storage materials and ideas easier.

The storage bed can be optimized to enhance surface area for the reaction without adversely affecting the power generating unit. Volumetric expansion/contraction associated with the discharge and charge reactions can be effectively managed with an external bed without impacting the power generating unit design. Further reliability of the energy storage system is enhanced as the storage bed performance can be monitored independent of the power generating unit, which can be protected with redundancies of gas flows for reliable and uninterrupted operation.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A fuel cell/electrolyzer system capable of charging and discharging, with an energy storage function, comprising:
(a) a source of fuel;
(b) a source of electricity;
(c) an optional reformer receiving the source of fuel and outputting a feed stream of H₂O/steam;
(d) a feed stream of H₂O/steam;
(e) an energy storage subunit which receives the feed stream and which subunit contains a metal based material which provides a metal oxide and hydrogen at discharge where the metal oxide is retained in the energy storage subunit providing hydrogen rich fuel of H₂ and steam, with a volume % ratio hydrogen: steam of 60 to 75:25 to 40;
(f) a thermal energy source to heat the discharged hydrogen rich H₂ and steam to provide a hydrogen rich H₂ and steam fuel entry stream having a temperature over about 750° C.;
(g) a fuel cell power generator/electrolyzer that is completely separated from all other components in the system, which fuel cell power generator/electrolyzer receives the heated, hydrogen rich H₂ and steam entry stream, said fuel cell power generator/electrolyzer providing energy out, depleted oxidant out and depleted H₂ fuel of H₂O and steam; and which electrolyzer will split water into H₂ and O₂ during charging when the electricity source is fed into the system;
(h) an oxidant source which is passed to the fuel cell power generator/electrolyzer; and
(i) separate additional storage media subunit containing a metal based material to be fed with the depleted fuel out, which metal based material will chemically charge the depleted H₂ fuel of H₂O and steam exiting the fuel cell power generator/electrolyzer, to provide recirculated fuel of higher H₂ content plus steam which is passed to the energy storage subunit of (e); where at steady state operation the source of fuel (a), and optional reformer (c) can be eliminated or their output reduced.

2. The fuel cell system/electrolyzer of claim 1, wherein the fuel cell is selected from the group consisting of solid oxide fuel cells, phosphoric acid fuel cells, molten carbonate fuel cells and protein exchange membrane fuel cells.

3. The fuel cell system/electrolyzer of claim 1, wherein the storage metal material is selected from the group consisting of Fe, Mn, Co, Cr, Al, Zr, Se, Y, La, Ti, Hf, Ce, Cr, Ni, Cu, Nb, Ta, V, Mo, Pd, W and their alloys or oxides, halides, sulfates, sulfites and carbonates.

4. The fuel cell system/electrolyzer of claim 1, wherein the storage metal material is selected from the group consisting of Fe, Mn, Co, Cr, Al, Zr and their alloys and their oxides.

5. The fuel cell system/electrolyzer of claim 1, wherein the storage metal material is Fe or iron oxides.

6. The fuel cell system/electrolyzer of claim 1, wherein the fuel cell power generator/electrolyzer comprises a plurality of electrodes which receive the heated hydrogen rich H₂ and steam fuel entry stream and a plurality of “air” electrodes which receive and oxidant source, with electrolyte between each anode and air electrode.

7. The fuel cell system of claim 1, wherein an optional, separate storage media subunit is utilized to directly add storage material to the storage material subunit.

8. The fuel cell system/electrolyzer of claim 6, wherein the storage metal material in the separate storage media subunit is selected of the group consisting of Fe, Mn, Co, Cr, Al, Zr, Se, Y, La, Ti, Hf, Ce, Cr, Ni, Cu, Nb, Ta, V, Mo, Pd, W and their alloys or oxides.

9. The fuel cell system/electrolyzer of claim 7, wherein the storage metal materials in the separate storage media subunit is selected from the group consisting of Fe, Mn, Co, Cr, Al, Zr and their alloys and their oxides.

10. The fuel cell system/electrolyzer of claim 6, wherein the storage metal materials in the separate storage media subunit is selected from the group consisting of iron or iron oxide.

11. The fuel cell system/electrolyzer of claim 1, wherein the storage media subunits will generate heat while providing higher H₂ content to recirculated fuel.

12. The fuel cell system/electrolyzer of claim 1, wherein the storage media subunits will be situated in close proximity to the fuel cell power generation unit to absorb heat from said unit.
